(19) United States
(12) Patent Application Publication
(10) Pub. No.: US 2007/0214311 A1
(43) Pub. Date: Sep. 13, 2007

(54) Homogeneous device initialization of data storage library subsystems which may have heterogeneous devices

(76) Inventors: Robert Douglas Burchfield, Brentwood, CA (US); Erika Marianna Dawson, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/372,546

(22) Filed: Mar. 10, 2006

(51) Int. Cl. G06F 13/00

(52) U.S. Cl. 711/111

(57) ABSTRACT

Device initialization of subsystems of a data storage library determines whether a subsystem is homogeneous, having common types of devices; or is heterogeneous, having mixed types of devices. Host names are provided for a subsystem in a predetermined format by concatenating the library name, the subsystem name, and a supplemental character; where the supplemental character is a non-defining character for a homogeneous subsystem. For naming purposes, a heterogeneous mixed device subsystem is partitioned into partitions of devices having common types of devices, each partition characterized as a separate homogeneous subsystem with a host name implementing the supplemental character as a defining character.

### FIELD OF THE INVENTION

This invention relates to subsystems of data storage libraries, and, more particularly, to device initialization of the subsystems.

### BACKGROUND OF THE INVENTION

Data storage libraries provide a means of storing large amounts of data for host computer systems. The libraries typically comprise large numbers of data storage media that are stored in storage shelves, numbers of data storage drives to read and write data with respect to the data storage media, one or more robot accessors to access the data storage media to move the data storage media between the storage shelves and data storage drives, and control units to control the operation of the library and control the flow of data and information between the library and host computer systems. Data storage library subsystems may also be manual, that is, without robotics, in which data storage media are manually moved to and from the data storage drives. In one example, such as the IBM® z/OS operating system for host systems, there is a requirement that all of the physical data storage drives of a data storage library, such as the IBM® 3494 or 3584 library, that are attached to a tape control unit, such as the IBM® 3592 control unit, must be of identical type or considered “homogeneous”. One reason for this requirement is to ensure that a tape written by a data storage drive may be read or written by any other data storage drive attached to the same tape control unit. When data storage drives are upgraded, they may be backwards compatible for read purposes, but not for writing, for example, as with the IBM® 3590 drive technology, the data density of the magnetic tape to be written will be different, but the tape drive may still be able to read at the prior lower density. In other cases, as with the newer IBM® 3592 drive technology, the data storage drives may be backwards compatible for read and for write purposes, however the data density of the magnetic tape to be written can also record at the higher density. In either case, homogeneity is required to avoid a lower density data storage drive from attempting to append data to a higher density data storage media. It may not be economically wise to require that all of the devices be upgraded simultaneously. In other instances, the drives may be configured to emulate the lower density, allowing customers to add drives to an existing control unit, but it may not be economically wise to operate the newer density devices at the lower density. Thus customers are prevented from using high density drives added to an existing control unit, and most, for example, buy new library frames and another control unit, or operate newer high density devices at the lower density.

### SUMMARY OF THE INVENTION

Computer systems, computer program products and methods for conducting device initialization naming of at least one subsystem of a data storage library, comprising the steps of:

determining the types of devices of the subsystem;

determining whether a subsystem is homogeneous, having common types of devices; or whether it is heterogeneous, having mixed types of devices;

providing host names for the subsystem in a predetermined format by concatenating the library name, the subsystem name, and a supplemental character;

implementing the supplemental character as a non-defining character for a homogeneous subsystem; and

partitioning a heterogeneous mixed device subsystem into partitions for naming purposes, the partitions comprising partitions of devices having common types of devices, each partition characterized as a separate homogeneous subsystem with a host name for the partition implementing the supplemental character as a defining character.

In a further embodiment, non-defining character comprises an asterisk (*).

In another embodiment, the predetermined format arranges the supplemental character of the host names to be ignored by host software.

In a further embodiment, the subsystem comprises a physical subsystem comprising a control unit, and each of the partitioned subsystems comprises the control unit of the physical subsystem.

For a fuller understanding of the present invention, reference should be made to the following detailed description taken in conjunction with the accompanying drawings.

### BRIEF DESCRIPTION OF THE DRAWINGS

FIG. 1 is an isometric illustration of an automated data storage library which may implement the present invention;

FIG. 2 is an illustration view of an opened frame of the automated data storage library of FIG. 1;

FIG. 3 is a block diagram of an embodiment of a host system and of the automated data storage library of FIGS. 1 and 2;

FIG. 4 is a diagrammatic illustration of an embodiment of the organization and naming of the data storage drives of FIGS. 1, 2, 3 and 4; and

FIG. 5 is a flow chart depicting an embodiment of a method to provide the organization and naming of FIG. 4.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

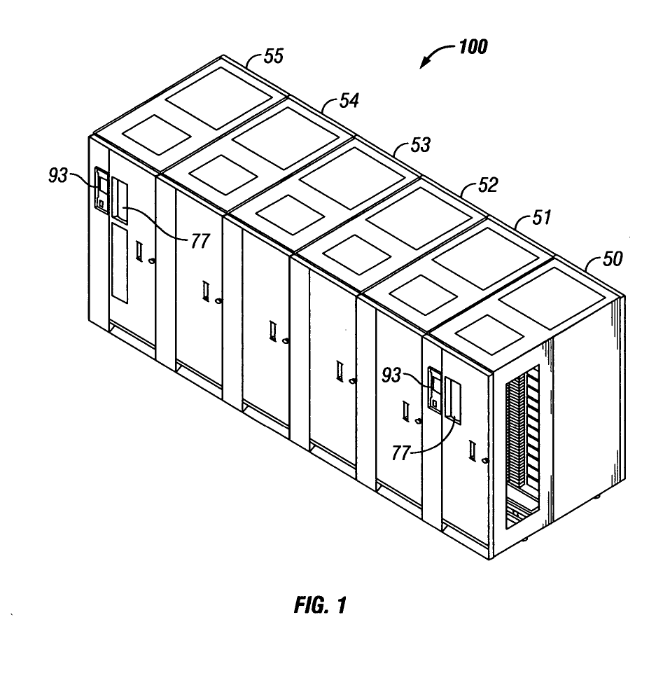

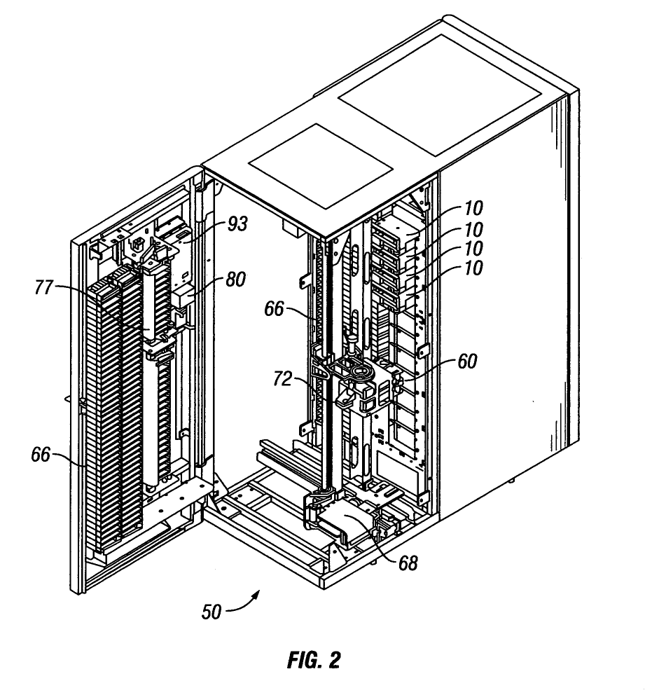

FIGS. 1, 2 and 3 illustrate an embodiment of an automated data storage library 100, configured in accordance with the present invention, which is arranged to access data storage media, such as magnetic tape cartridges, typically in response to commands from at least one external host system 21, and comprises one or more frames 50, 51, 52, 53, 54, and 55, each of which has a plurality of storage shelves 66 for storing the data storage media, and may have a plurality of data storage drives 10 and 11 for reading and/or writing data with respect to the data storage media. The library 100 further comprises at least one robot accessor 68 for transporting the data storage media between the storage shelves 66 and the data storage drives 10 and 11. The robot accessor 68 comprises a gripper assembly 60 for gripping one or more of the data storage media, and may comprise an accessor sensor 72 to read the labels of the data storage media. Magnetic tape data storage cartridges may be added to or removed from the library, for example, at input/output stations 77.

The library 100 also comprises control units 80, 81, 83, 84 and 85, which may be distributed among the frames to operate the library, communicate with a host system 21, and communicate with the data storage drives 10 and 11. Alternatively, additional library control units may operate the library, while the control units 80, 81, 83, 84 and 85, communicate with the host system and with the data storage drives 10 and 11. Further, the library may provide one or more operator panels 93 for communicating with the library controller(s). In the illustrated example, frame 52 comprises storage shelves 66 and no data storage drives or control unit. An example of an automated data storage library comprises the IBM® 3584 tape library, and another example of an automated data storage library comprises the IBM® 3494 tape library.

A host system 21 typically comprises one or more computer processors and an operating system that typically comprises program code, such as one or more operating systems 22 for operating the computer processor(s). Herein “processor” may comprise any suitable logic, microprocessor, and associated memory for responding to program instructions, and the associated memory may comprise fixed or rewritable memory or data storage devices. The program code may be supplied to the host system directly as from a data storage device or memory, for example by an input from an optical disk, or by being read from a magnetic tape cartridge, or from a network, or by any other suitable means.

Device initialization program code 92 may form a part of the operating system 22, and comprises a computer program product embodied on a computer readable medium, configured to be usable with at least one programmable computer processor. At least a portion of the device initialization program code is configured to conduct device initialization naming of subsystems of an automated data storage library, such as library 100. Device initialization may refer to program code provided by the device owner that executes when a device is to be used by the computer system. This is generally described as the process of varying a device online, but initialization can also take place when a device is “discovered” by the operating system, even if the device is not being varied online. The naming process comprises establishment of esoteric names of the subsystems for management of the support for the operation of the library. These names are not necessarily related to addresses. The computer program product may employ other aspects of the host system, or other intermediate systems, such as interfaces to the library, for example a network, and of the library, to carry out the operations.

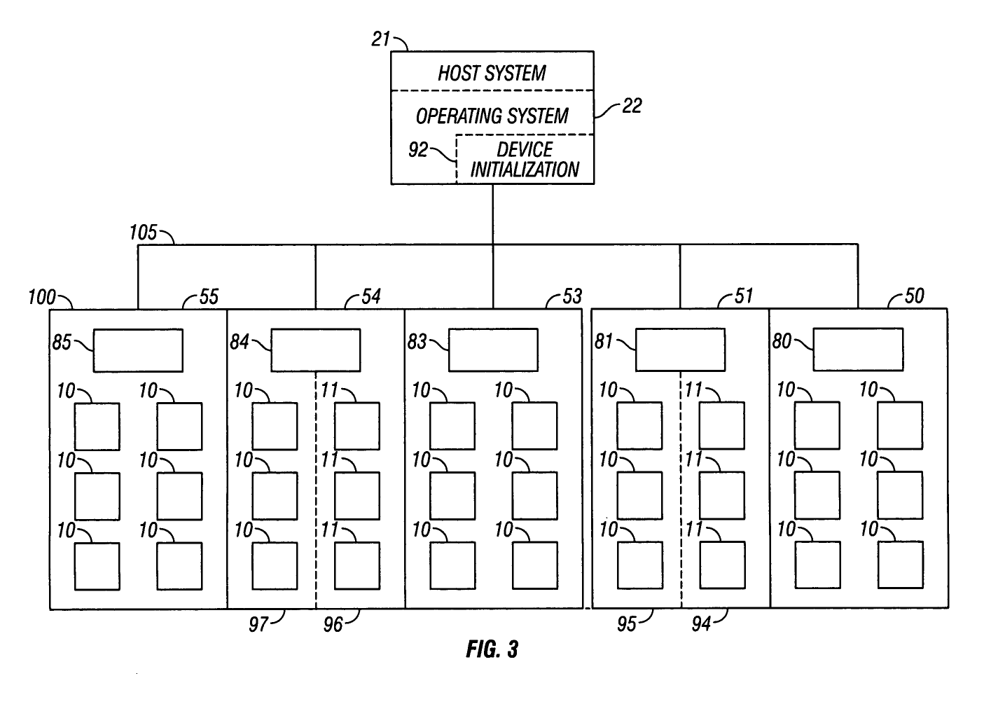

Referring to FIGS. 3, 4 and 5, the data storage drives 10 may comprise down-level data storage drives, and data storage drives 11 may be considered upgraded data storage drives. As discussed above, one reason for a “homogeneous” requirement is to ensure that a tape written by a data storage drive may be read or written by any other data storage drive attached to the same tape control unit. When data storage drives are upgraded, they may be backwards compatible for read purposes, but not for writing, for example, as with the IBM® 3590 drive technology, the data density of the magnetic tape to be written will be different, but the tape drive may still be able to read at the prior lower density. In other cases, as with the newer IBM® 3592 drive technology, the data storage drives may be backwards compatible for read and for write purposes, however the data density of the magnetic tape to be written can also record at the higher density. In either case, homogeneity is required to avoid a lower density data storage drive from attempting to append data to a higher density data storage media. It may not be economically wise to require that all of the devices be upgraded simultaneously. In other instances, the drives may be configured to emulate the lower density, allowing customers to add drives to an existing control unit, but it may not be economically wise to operate the newer density devices at the lower density. Thus customers are prevented from using high density drives added to an existing control unit, and most, for example, buy new library frames and another control unit, or operate newer high density devices at the lower density. The present invention allows customers to add drives to an existing control unit, comprising a heterogeneous or mixed subsystem, without for example, buying new library frames and another control unit, or allows customers to for example, use dual density data storage drives at either density. Examples of data storage drives comprise magnetic tape data storage drives, such as the IBM® 3592 Model E05 and IBM® 3592 Model J1A magnetic tape data storage drives.

Device initialization is conducted at step 106, and in step 107, communication is conducted with respect to the library 100, for example over interface 105, which may comprise a network or other means of communication, to determine the types of devices of at least one of the subsystems. For example, a subsystem comprises a frame 50, 51, 53, 54, or 55, having a control unit 80, 81, 83, 84 or 85, respectively. The control units 80, 81, 83, 84 or 85 detect and communicate with the data storage drives 10 and 11 to ascertain the types of devices that are employed in the subsystem, and this information is forwarded, for example, on request, to the device initialization program code 92. Step 107 may be conducted for all subsystems of a library, or may be conducted individually as a subsystem becomes available.

In step 110, a determination is made whether the subsystem is homogeneous, having common types of devices; or whether it is heterogeneous, having mixed types of devices. For example, the subsystem of frame 50 and control unit 80 comprises only data storage drives 10, and is therefore homogeneous. The same holds true for the subsystems of frames 53 and 55 and control units 83 and 85. The subsystems of frames 51 and 54 and control units 81 and 84 comprise both data storage drives 10 and data storage drives 11, and are therefore heterogeneous.

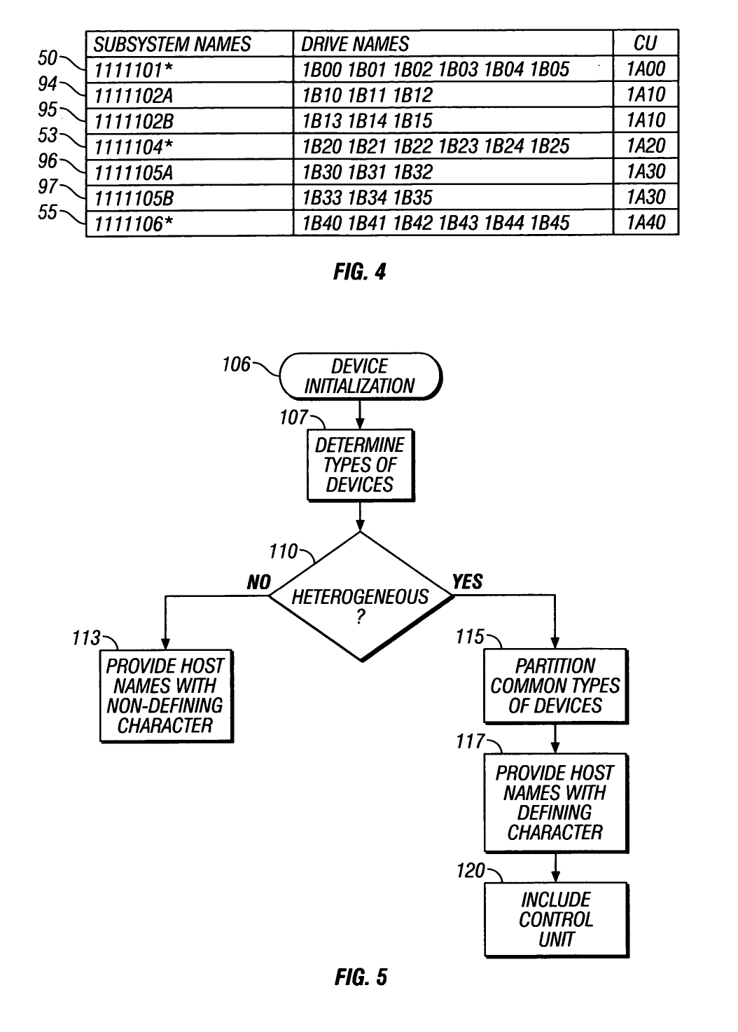

For a homogeneous subsystem, such as the subsystems of frames 50, 53 and 55 and control units 80, 83 and 85, step 113 provides host names for the subsystem in a predetermined format by concatenating the library name, the subsystem name, and a supplemental character; and the supplemental character is implemented as a non-defining character. For example, the subsystem name of the library 100 may comprise a five character name, such as “11111”, and the subsystem frames may comprise two character names, such as “01”, “02”, etc. Thus, in FIG. 4, the subsystem 50 of FIG. 3 comprises “1111101”, to which is concatenated a supplemental character. The supplemental character may comprise one or more multi-bit digital indicators, for example, 16 bits, in any suitable code. In one embodiment, the non-defining character comprises a filler, such as an asterisk (*). The device names may also be provided, and examples are depicted in FIG. 4. The format of the character names for the subsystems is such that only the highest order characters have significance, such that the supplemental character is treated as a filler or pad by the host software, for example, in operating the library 100 and the subsystems of FIG. 3. This leaves the host software support as using the entire 8 character name as just a name for comparison or other uses.

FIG. 4 additionally depicts the control units for the homogeneous subsystems.

For a heterogeneous subsystem, step 115 of FIG. 5 partitions the heterogeneous mixed device subsystem into partitions for naming purposes, the partitions comprising partitions of devices having common types of devices. For example, subsystem frame 51 of FIG. 3 is partitioned into partitions 94 and 95. Partition 94 comprises the common type data storage devices 11, and partition 95 comprises the common type of data storage devices 10. In step 117, each partition is characterized as a separate homogeneous subsystem with a host name for the partition implementing the supplemental character as a defining character. Referring to FIG. 4, partitioned subsystem 94 of subsystem frame 51 is characterized as a homogeneous subsystem and provided with the five character library name, such as “11111”, and the subsystem frames two character name, such as “02”, as discussed above, and the defining supplemental character comprises an “A”. Thus, the partition 94 comprises “1111102A”. The partitioned subsystem 95 of subsystem frame 51 is also characterized as a homogeneous subsystem and provided with the five character library name, such as “11111”, and the subsystem frames two character name, such as “02”, as discussed above, and the defining supplemental character comprises an “B”. Thus, the partition 95 comprises “1111102B”. The defining supplemental characters thereby define the partitions as homogeneous subsystems, partition 94 with data storage drives having the characteristics of data storage devices 11, and partition 95 with data storage drives having the characteristics of data storage devices 10. Similarly, subsystem frame 54 is partitioned into partitions 96 and 97 having common types of devices.

In step 120, the physical control unit of the physical subsystem is allocated to both of the partitioned subsystems, such that each partition comprises the control unit of the physical subsystem. Thus, both partitions 94 and 95 comprise the control unit 81 of FIG. 3. Similarly, the physical control unit 84 is allocated to both partitioned subsystems 96 and 97.

Those of skill in the art will understand that changes may be made with respect to the specific naming characters and naming conventions, and that the steps of FIG. 5 may be conducted simultaneously for all subsystems, and may be arranged in a different order. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A computer implemented method for conducting device initialization naming of at least one subsystem of a data storage library, comprising the steps of:
determining the types of devices of said at least one subsystem;
determining whether a subsystem is homogeneous, having common types of devices; or
whether said subsystem is heterogeneous, having mixed types of devices;
providing host names for said at least one subsystem in a predetermined format by concatenating the library name, the subsystem name, and a supplemental character;
implementing said supplemental character as a non-defining character for a homogeneous said subsystem; and
partitioning a heterogeneous mixed device said subsystem into partitions for naming purposes, said partitions comprising partitions of devices having common types of devices, each said partition characterized as a separate homogeneous subsystem with a host name for said partition implementing said supplemental character as a defining character.

2. The method of claim 1, wherein said non-defining character comprises an asterisk (*).

3. The method of claim 1, wherein said predetermined format arranges said supplemental character of said host names to be treated as a filler by host software.

4. The method of claim 1, wherein said at least one subsystem comprises a physical subsystem comprising a control unit, and wherein said partitioned subsystems each comprises said control unit of said physical subsystem.

5. A computer program product embodied on a computer readable medium, configured to be usable with at least one programmable computer processor to conduct device initialization naming of at least one subsystem of a data storage library, comprising:
computer readable program code causing said at least one programmable computer processor to determine the types of devices of said at least one subsystem;
computer readable program code causing said at least one programmable computer processor to determine whether a subsystem is homogeneous, having common types of devices;
or whether said subsystem is heterogeneous, having mixed types of devices;
computer readable program code causing said at least one programmable computer processor to provide host names for said at least one subsystem in a predetermined format by concatenating the library name, the subsystem name, and a supplemental character;
computer readable program code causing said at least one programmable computer processor to implement said supplemental character as a non-defining character for a homogeneous said subsystem; and
computer readable program code causing said at least one programmable computer processor to partition a heterogeneous mixed device said subsystem into partitions for naming purposes, said partitions comprising partitions of devices having common types of devices, each said partition characterized as a separate homogeneous subsystem with a host name for said partition implementing said supplemental character as a defining character.

6. The computer program product of claim 5, wherein said non-defining character comprises an asterisk (*).

7. The computer program product of claim 5, wherein said predetermined format arranges said supplemental character of said host names to be treated as a filler by host software.

8. The computer program product of claim 5, wherein said at least one subsystem comprises a physical subsystem comprising a control unit, and wherein said partitioned subsystems each comprises said control unit of said physical subsystem.

9. A computer system configured to conduct device initialization naming of at least one subsystem of a data storage library, comprising:
at least one interface configured to communicate with said at least one subsystem; and
at least one computer processor configured to perform the steps of:
communicating via said at least one interface to determine the types of devices of said at least one subsystem;
determining whether a subsystem is homogeneous, having common types of devices; or whether said subsystem is heterogeneous, having mixed types of devices;
providing host names for said at least one subsystem in a predetermined format by concatenating the library name, the subsystem name, and a supplemental character;
implementing said supplemental character as a non-defining character for a homogeneous said subsystem; and
partitioning a heterogeneous mixed device said subsystems into partitions for naming purposes, said partitions comprising partitions of devices having common types of devices, each said partition characterized as a separate homogeneous subsystem with a host name for said partition implementing said supplemental character as a defining character.

10. The computer system of claim 9, wherein said non-defining character comprises an asterisk (*).

11. The computer system of claim 9, wherein said predetermined format arranges said supplemental character of said host names to be treated as a filler by host software.

12. The computer system of claim 9, wherein said at least one subsystem comprises a physical subsystem comprising a control unit, and wherein said partitioned subsystems each comprises said control unit of said physical subsystem.
